(19) United States
(12) Patent Application Publication
(10) Pub. No.: US 2022/0344723 A1
(43) Pub. Date: Oct. 27, 2022

(54) NONAQUEOUS ELECTROLYTE SECONDARY BATTERY

(71) Applicant: Prime Planet Energy & Solutions, Inc., Tokyo (JP)

(72) Inventor: Hiroaki KAWASE, Kakogawa-shi (JP)

(21) Appl. No.: 17/727,817

(22) Filed: Apr. 25, 2022

(30) Foreign Application Priority Data
Apr. 26, 2021 (JP) 2021-073924

(51) Int. Cl. H01M 10/0587; H01M 50/543

(52) U.S. Cl. CPC H01M 10/0587; H01M 50/543

(57) ABSTRACT

An electrode assembly includes a laminated assembly. The laminated assembly includes a positive electrode plate, a separator, and a negative electrode plate. Each of the positive electrode plate, the separator, and the negative electrode plate has a strip-like planar shape. The laminated assembly is spirally wound. In a cross section orthogonal to a winding axis of the laminated assembly, the electrode assembly includes a first curved portion, a flat portion, and a second curved portion. Winding of the positive electrode plate is terminated in the second curved portion. A winding- terminated position of the positive electrode plate is located beyond a peak of the second curved portion. The negative electrode plate includes a negative electrode substrate and a negative electrode active material layer. The negative electrode substrate includes an exposed portion on each of both sides of the negative electrode plate in a width direction.

This nonprovisional application is based on Japanese Patent Application No. 2021-073924 filed on Apr. 26, 2021, with the Japan Patent Office, the entire contents of which are hereby incorporated by reference.

### BACKGROUND OF THE INVENTION

### Field of the Invention

The present technology relates to a nonaqueous electrolyte secondary battery.

### Description of the Background Art

Japanese Patent Laying-Open No. 2015-220216 discloses that an aging process is performed to avoid elution of a metal in a positive electrode active material.

### SUMMARY OF THE INVENTION

Generally, a method of manufacturing a nonaqueous electrolyte secondary battery (hereinafter, simply referred to as “battery”) includes an assembling step, a liquid injecting step, and a sealing step. In the assembling step, an electrode assembly is formed. The electrode assembly can be of a wound type. The electrode assembly can be accommodated in an exterior package. In the liquid injecting step, an electrolyte solution is injected into the exterior package. In the sealing step, the exterior package is sealed. The liquid injecting step and the sealing step are performed in a low-moisture atmosphere. This is because battery performance can be decreased when moisture is introduced into the battery.

Conventionally, a nitrogen atmosphere has been used as the low-moisture atmosphere. The nitrogen atmosphere is not only the low-moisture atmosphere but also an extremely-low-oxygen atmosphere. In view of, for example, manufacturing cost or the like, it is desired that the liquid injecting step and the sealing step can be performed even in an oxygen-containing atmosphere.

For example, it is considered to use a dry air atmosphere. The dry air atmosphere can be the low-moisture atmosphere and the oxygen-containing atmosphere. However, when the liquid injecting step and the sealing step are performed in the oxygen-containing atmosphere, a ratio of occurrence of voltage failure tends to be increased.

An object of the present technology is to reduce a ratio of occurrence of voltage failure.

Hereinafter, configurations, functions, and effects of the present technology will be described. It should be noted that a mechanism of function in the present specification includes presumption. The scope of the present technology is not limited by the mechanism of the function.

[1] A nonaqueous electrolyte secondary battery includes: an exterior package; an electrode assembly; and an electrolyte solution.

The exterior package accommodates the electrode assembly and the electrolyte solution. The exterior package includes a container and an external terminal. The container includes a bottom portion, a top portion, and a sidewall. The sidewall connects the bottom portion and the top portion to each other. The external terminal is attached to the top portion.

The electrode assembly includes a laminated assembly. The laminated assembly includes a positive electrode plate, a separator, and a negative electrode plate. Each of the positive electrode plate, the separator, and the negative electrode plate has a strip-like planar shape. The positive electrode plate, the separator, and the negative electrode plate are layered. The separator separates the positive electrode plate and the negative electrode plate from each other. The laminated assembly is spirally wound. In a cross section orthogonal to a winding axis of the laminated assembly, the electrode assembly includes a first curved portion, a flat portion, and a second curved portion. In each of the first curved portion and the second curved portion, the laminated assembly is curved. In the flat portion, the laminated assembly is flat. In a direction connecting the bottom portion and the top portion of the container to each other, the second curved portion is close to the bottom portion with respect to the first curved portion. The flat portion connects the first curved portion and the second curved portion to each other.

Winding of the positive electrode plate is terminated in the second curved portion. A winding-terminated position of the positive electrode plate is located beyond a peak of the second curved portion. The positive electrode plate includes a transition metal oxide.

The negative electrode plate includes a negative electrode substrate and a negative electrode active material layer. The negative electrode active material layer is disposed on a surface of the negative electrode substrate. The negative electrode substrate includes an exposed portion on each of both sides of the negative electrode plate in a width direction. The exposed portion protrudes outward with respect to an end surface of the negative electrode active material layer.

According to a new finding of the present technology, a mechanism of occurrence of voltage failure under an oxygen-containing atmosphere can be as follows.

FIG. 1 is a first schematic cross sectional view showing an electrode assembly in a reference embodiment.

An electrode assembly 220 is of a wound type. Electrode assembly 220 includes a first curved portion Rp1, a flat portion Fp, and a second curved portion Rp2.

FIG. 2 is a second schematic cross sectional view showing the electrode assembly in the reference embodiment.

FIG. 2 shows electrode assembly 220 when viewed in a line of sight parallel to a Y axis. Electrode assembly 220 of FIG. 2 is in a discharged state.

FIG. 3 is a third schematic cross sectional view showing the electrode assembly in the reference embodiment.

Electrode assembly 220 of FIG. 3 is in a charged state. By processing for current collection, negative electrode plate 222 is fixed at one end in an X axis direction. Negative electrode plate 222 can be expanded during charging. Due to the expansion of negative electrode plate 222, loosened winding may occur in electrode assembly 220 at a portion at which negative electrode plate 222 is not fixed. The loosened winding may be noticeable in a region IV. Region IV is included in the outermost perimeter. Due to the loosened winding, a space is formed between the electrodes. Due to the formation of the space, negative electrode plate 222 is exposed to surrounding oxygen gas (O₂).

FIG. 4 is a conceptual diagram showing a mechanism of occurrence of voltage failure.

FIG. 4 shows a positional relation between a positive electrode plate 221 and negative electrode plate 222 in region IV in each of FIGS. 1 to 3. Negative electrode plate 222 includes a negative electrode substrate 222c, a negative electrode active material layer 222a, and a negative electrode active material layer 222b. Positive electrode plate 221 includes a positive electrode substrate 221c, a positive electrode active material layer 221a, and a positive electrode active material layer 221b. Negative electrode active material layer 222a (inner peripheral side) faces positive electrode active material layer 221b (outer peripheral side). Negative electrode active material layer 222b (outer peripheral side) does not face positive electrode active material layers 221a, 221b. Negative electrode active material layer 222b (outer peripheral side) is a “non-facing portion”.

By performing a liquid injecting step and a sealing step under an oxygen-containing atmosphere, an atmosphere in the battery can be an oxygen-containing atmosphere. Negative electrode active material layer 222b is immersed in electrolyte solution 230. (i) Negative electrode active material layer 222b is exposed to oxygen gas (O₂), thereby consuming part of lithium ions (Li⁺). Thus, a concentration gradient of Li⁺ is caused. (ii) In order to reduce the concentration gradient of Li⁺, Li⁺ may be diffused from the negative electrode active material layer 222a side to the negative electrode active material layer 222b side. Hereinafter, in the present specification, this phenomenon is also referred to as “diffusion of Li⁺ to the non-facing portion”. (iii) In order to compensate for the reduction of Li in negative electrode active material layer 222a, positive electrode active material layer 221b supplies Li⁺ to negative electrode active material layer 222a. Thus, potential of positive electrode active material layer 221b can be increased locally. (iv) Due to the increase in potential, a transition metal can be eluted into the electrolyte solution from a transition metal oxide included in positive electrode active material layer 221b. The eluted transition metal can be precipitated on a surface of negative electrode active material layer 222a. The precipitation of the transition metal may cause voltage failure.

FIG. 5 is a schematic cross sectional view showing an electrode assembly in an embodiment of the present technology.

In the present technology, the ratio of occurrence of voltage failure can be reduced by a winding-terminated position of a positive electrode plate 121 and an exposed portion of a negative electrode substrate 122c.

In the reference embodiment described above, the winding of positive electrode plate 221 is terminated in flat portion Fp (see FIG. 1). In the present technology, the winding of positive electrode plate 121 is terminated in a second curved portion Rp2. The winding-terminated position of positive electrode plate 121 is located beyond a peak of second curved portion Rp2. Thus, tension Ts is considered to be applied to a region VI. With the application of tension Ts, it is expected to reduce loosened winding.

FIG. 6 is a conceptual diagram showing a function of the exposed portion of the negative electrode substrate.

FIG. 6 shows a positional relation between positive electrode plate 121 and negative electrode plate 122 in region VI in FIG. 5 In the present technology, negative electrode substrate 122c includes exposed portions (first exposed portion Ep1 and second exposed portion Ep2) on its both sides in the width direction (X axis direction). Second exposed portion Ep2 may be located in region VI. Second exposed portion Ep2 extends outward with respect to the end surfaces of negative electrode active material layers 122a, 122b. Second exposed portion Ep2 can physically inhibit the diffusion of Li to the non-facing portion. Thus, it is considered that a series of reactions leading to the precipitation of the transition metal can be inhibited.

With synergy of the above effects, it is expected to reduce the ratio of occurrence of voltage failure in the present technology.

[2] A length of the exposed portion may be larger than a thickness of the negative electrode active material layer, for example.

Since the exposed portion is longer than the thickness of the negative electrode active material layer, it is expected that the diffusion of Li⁺ to the non-facing portion (see FIG. 4) is less likely to occur.

[3] The length of the exposed portion may be more than or equal to 0.8 mm, for example.

Since the exposed portion is more than or equal to 0.8 mm, it is expected that the diffusion of Li⁺ to the non-facing portion is less likely to occur.

[4] The container is sealed. Gas in the container may have an oxygen gas concentration of more than or equal to 1% and less than or equal to 21% in mole fraction.

In the battery of the present technology, even when an atmosphere in the container is an oxygen-containing atmosphere, it is expected that voltage failure is less likely to occur.

The foregoing and other objects, features, aspects and advantages of the present technology will become more apparent from the following detailed description of the present technology when taken in conjunction with the accompanying drawings.

### BRIEF DESCRIPTION OF THE DRAWINGS

FIG. 1 is a first schematic cross sectional view showing an electrode assembly in a reference embodiment.

FIG. 2 is a second schematic cross sectional view showing the electrode assembly in the reference embodiment.

FIG. 3 is a third schematic cross sectional view showing the electrode assembly in the reference embodiment.

FIG. 4 is a conceptual diagram showing a mechanism of occurrence of voltage failure.

FIG. 5 is a schematic cross sectional view showing an electrode assembly in an embodiment of the present technology.

FIG. 6 is a conceptual diagram showing a function of an exposed portion of a negative electrode substrate.

FIG. 7 is a schematic diagram showing an exemplary nonaqueous electrolyte secondary battery in the embodiment of the present technology.

FIG. 8 is a schematic diagram of the electrode assembly in the embodiment of the present technology.

### DESCRIPTION OF THE PREFERRED EMBODIMENTS

Hereinafter, an embodiment (also referred to as “the present embodiment” in the present specification) of the present technology will be described. However, the scope of the present technology is not restricted by the following description. For example, a description regarding functions and effects in the present specification does not limit the scope of the present technology to the scope in which all the functions and effects are exhibited.

<Definitions of Terms, etc.>

In the present specification, expressions such as “comprise”, “include”, and “have” as well as their variants (such as “be composed of”, “encompass”, “involve”, “contain”, “carry”, “support”, and “hold”) are open-end expressions. Each of the open-end expressions may or may not further include additional element(s) in addition to essential element(s). The expression “consist of” is a closed expression. The expression “consist essentially of” is a semi-closed expression. The semi-closed expression may further include additional element(s) in addition to essential element(s) as long as the object of the present technology is not compromised. For example, a normally conceivable element (such as an inevitable impurity) in the field to which the present technology belongs may be included as an additional element.

In the present specification, each of the words “may”, “can” and the like is used in a permissible sense, i.e., “have a possibility to do”, rather than in a mandatory sense, i.e., “must do”.

In the present specification, elements expressed by singular forms (“a”, “an”, and “the”) may include plural forms as well, unless otherwise stated particularly. For example, the term “particle” means not only “one particle” but also an “aggregate (powdery body, powder, particle group) of particles”.

In the present specification, a numerical range such as “0.8 mm to 2.0 mm” and “0.8 to 2.0 mm” includes the lower and upper limit values unless otherwise stated particularly. That is, each of the expressions “0.8 mm to 2.0 mm” and “0.8 to 2.0 mm” represents a numerical range of “more than or equal to 0.8 mm and less than or equal to 2.0 mm”. Further, numerical values freely selected from the numerical range may be employed as new lower and upper limit values. For example, a new numerical range may be set by freely combining a numerical value described in the numerical range with a numerical value described in another portion of the present specification, table, figure, or the like.

In the present specification, all the numerical values are modified by the term “about”. The term “about” can mean, for example, ±5%, ±3%, ±1%, or the like. All the numerical values are approximate values that can be changed depending on a manner of use of the present technology. All the numerical values are indicated as significant figures. Each of all the measurement values or the like can be rounded off based on the number of digits of each significant figure. Each of all the numerical values may include an error resulting from a detection limit or the like, for example.

In the present specification, when a compound is expressed by a stoichiometric composition formula such as “LiCoO₂”, the stoichiometric composition formula merely indicates a representative example. The composition ratio may be non-stoichiometric. For example, when a lithium cobaltate is expressed as “LiCoO₂”, the lithium cobaltate is not limited to a composition ratio of “Li/Co/O=1/1/2” unless otherwise stated particularly, and can include Li, Co, and O at any composition ratio. Further, doping or substitution with a small amount of element may also be permitted.

Geometric terms in the present specification (for example, the terms such as “parallel”, “perpendicular”, and “orthogonal”) should not be interpreted in a strict sense. For example, the term “parallel” may be deviated to some extent from the strict definition of the term “parallel”. The geometric terms in the present specification can include, for example, a tolerance, an error, and the like in terms of design, operation, manufacturing, and the like. A dimensional relation in each of the figures may not coincide with an actual dimensional relation. In order to facilitate understanding of the present technology, the dimensional relation (length, width, thickness, or the like) in each figure may be changed. Further, part of configurations may be omitted.

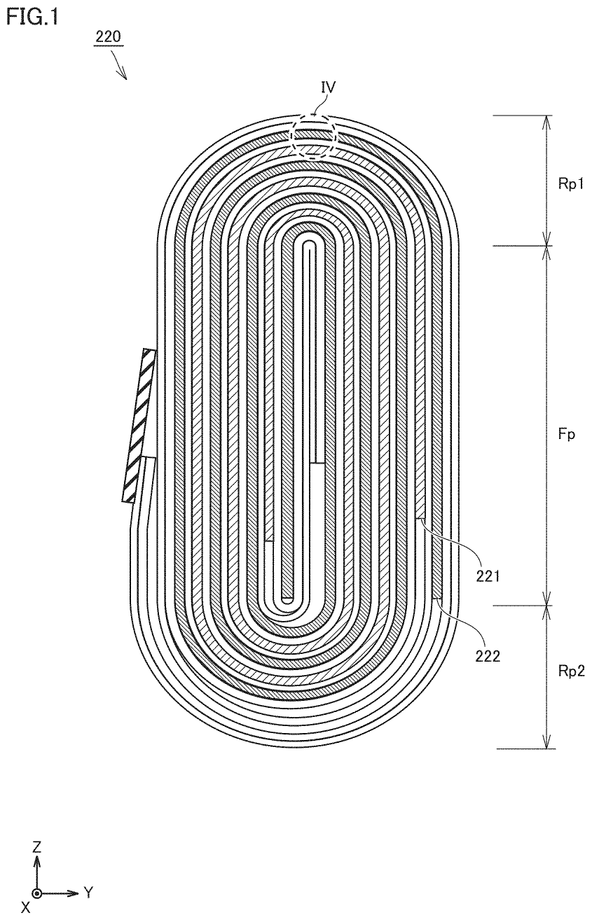

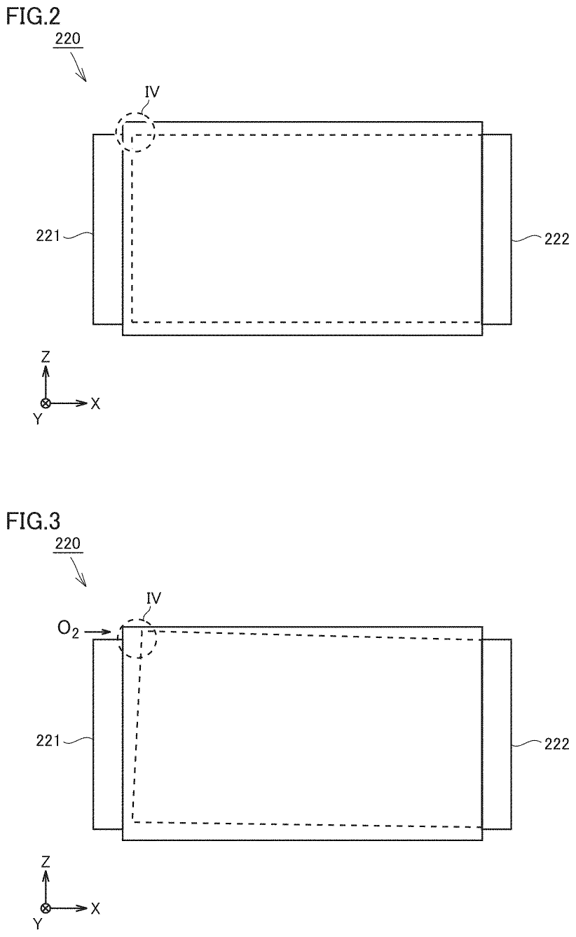

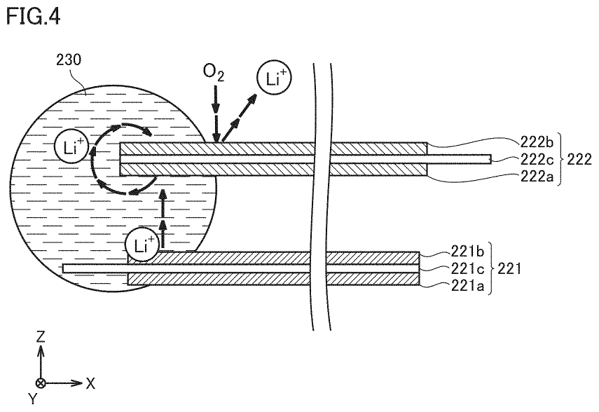

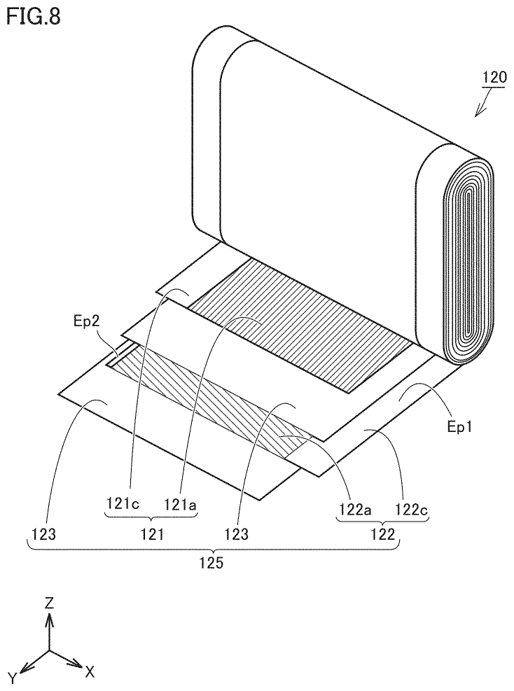

In the present specification, the “direction connecting the bottom portion and the top portion of the container to each other (Z axis direction in FIGS. 1, 7, and the like)” is also referred to as “height direction”. It should be noted that a relation between the height direction and the vertical direction is arbitrary. The height direction may or may not be parallel to the vertical direction.

<Nonaqueous Electrolyte Secondary Battery>

FIG. 7 is a schematic diagram showing an exemplary nonaqueous electrolyte secondary battery in an embodiment of the present technology.

Battery 100 can be used for any purpose of use. Battery 100 may be used as a main electric power supply or a motive power assisting electric power supply in an electrically powered vehicle or the like, for example. A plurality of batteries 100 may be coupled to form a battery module or a battery pack. Battery 100 may have a rated capacity of 1 to 200 Ah, for example.

«Exterior Package»

Battery 100 includes an exterior package 110. Exterior package 110 accommodates an electrode assembly 120. Exterior package 110 has a prismatic shape (rectangular parallelepiped shape). Exterior package 110 includes a container 111 and an external terminal 112. Container 111 may be composed of a metal, for example. Container 111 may be composed of an aluminum (Al) alloy or the like, for example. Container 111 includes a bottom portion 111a, a top portion 111b, and a sidewall 111c. Sidewall 111c connects bottom portion 111a and top portion 111b to each other.

Container 111 is sealed. An atmosphere in container 111 can be an oxygen-containing atmosphere. For example, gas in container 111 may have an oxygen gas concentration of 1 to 21% in mole fraction (amount of substance fraction) or may have an oxygen gas concentration of 5 to 15% in mole fraction (amount of substance fraction). The oxygen gas concentration can be measured by gas chromatography. The oxygen gas concentration can be measured three or more times. An arithmetic mean of the three or more results can be employed.

For example, by sealing container 111 in a dry air atmosphere, the atmosphere in container 111 can become an oxygen-containing atmosphere. The dry air atmosphere may have an oxygen gas concentration comparable to that of the atmospheric air. The dry air atmosphere may have an oxygen partial pressure of, for example, 160 mmHg. For example, when container 111 is sealed under a nitrogen atmosphere, the oxygen gas concentration of the gas in container 111 can be less than 1 ppm in mole fraction. It should be noted that the oxygen gas concentration in container 111 can be lower than the oxygen gas concentration in the dry air atmosphere. This is because various types of gases can be generated in container 111 due to decomposition or the like of the electrolyte solution.

External terminal 112 is attached to top portion 111b. External terminal 112 includes a positive electrode terminal 112a and a negative electrode terminal 112b. A positive electrode collector plate 113a connects positive electrode terminal 112a and electrode assembly 120 to each other. Each of positive electrode terminal 112a and positive electrode collector plate 113a may be composed of Al, for example. A negative electrode collector plate 113b connects negative electrode terminal 112b and electrode assembly 120 to each other. Each of negative electrode terminal 112b and negative electrode collector plate 113b may be composed of, for example, copper (Cu), nickel (Ni), or the like.

«Electrode Assembly»

Battery 100 includes electrode assembly 120. Battery 100 may include one electrode assembly 120 solely or may include a plurality of electrode assemblies 120. That is, exterior package 110 may accommodate the plurality of electrode assemblies 120.

FIG. 8 is a schematic diagram of the electrode assembly in the embodiment of the present technology.

Electrode assembly 120 includes a laminated assembly 125. Laminated assembly 125 includes a positive electrode plate 121, a separator 123, and a negative electrode plate 122. Laminated assembly 125 may include one separator 123 solely. Laminated assembly 125 may include, for example, two separators 123. Each of positive electrode plate 121, separator 123, and negative electrode plate 122 has a strip-like planar shape. Positive electrode plate 121, separator 123, and negative electrode plate 122 are layered. For example, separator 123, positive electrode plate 121, separator 123, and negative electrode plate 122 may be layered in this order. At least a portion of separator 123 is interposed between positive electrode plate 121 and negative electrode plate 122. Separator 123 separates positive electrode plate 121 and negative electrode plate 122 from each other.

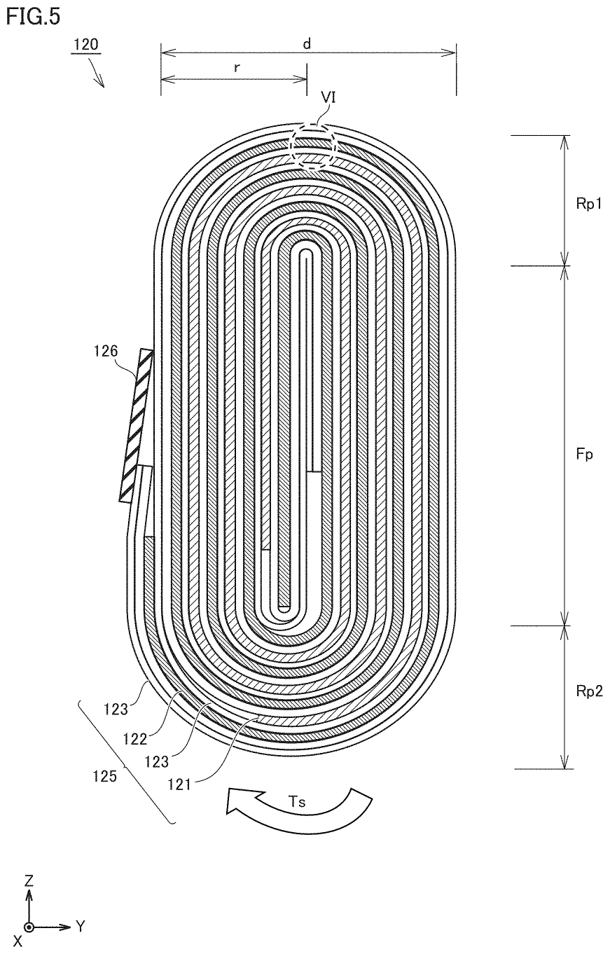

FIG. 5 shows a cross section orthogonal to a winding axis of laminated assembly 125. Laminated assembly 125 is spirally wound. For example, laminated assembly 125 wound to have a tubular shape may be shaped to have a flat shape, thereby forming electrode assembly 120. Laminated assembly 125 may be wound to have the flat shape. A terminal end of laminated assembly 125 may be fixed by, for example, an adhesive tape 126 or the like.

The Z axis direction in FIG. 5 corresponds to the height direction. The “height direction” is the direction connecting bottom portion 111a and top portion 111b of container 111 to each other. In the height direction, electrode assembly 120 includes a first curved portion Rp1, a flat portion Fp, and a second curved portion Rp2. In flat portion Fp, laminated assembly 125 is flat. In each of first curved portion Rp1 and second curved portion Rp2, laminated assembly 125 is curved. In each of first curved portion Rp1 and second curved portion Rp2, laminated assembly 125 may form a circular arc. For example, when the outer shape of each of first curved portion Rp1 and second curved portion Rp2 forms a circular arc, radius r of the circle and thickness d of electrode assembly 120 may satisfy the following relation: “2r≈d”.

In the height direction, second curved portion Rp2 is close to bottom portion 111a (see FIG. 7) with respect to first curved portion Rp1. Flat portion Fp is sandwiched between first curved portion Rp1 and second curved portion Rp2. Flat portion Fp connects first curved portion Rp1 and second curved portion Rp2 to each other.

(Positive Electrode Plate)

Positive electrode plate 121 is a sheet having a strip-like shape. Winding of positive electrode plate 121 is terminated in second curved portion Rp2 (see FIG. 5). The winding-terminated position of positive electrode plate 121 is located beyond the peak of second curved portion Rp2. The “peak” represents a point of second curved portion Rp2 that protrudes the most toward the bottom portion 111a side. Since the winding of positive electrode plate 121 is terminated with positive electrode plate 121 extending over the peak of second curved portion Rp2, tension Ts is expected to be applied to first curved portion Rp1. With the application of tension Ts, it is expected to reduce loosened winding.

For example, as a dynamic coefficient of friction is larger between positive electrode plate 121 and separator 123, the loosened winding is expected to be more reduced. The dynamic coefficient of friction between positive electrode plate 121 and separator 123 may be, for example, 0.50 to 1.00. The “dynamic coefficient of friction” in the present specification can be measured in accordance with “JIS K 7125”.

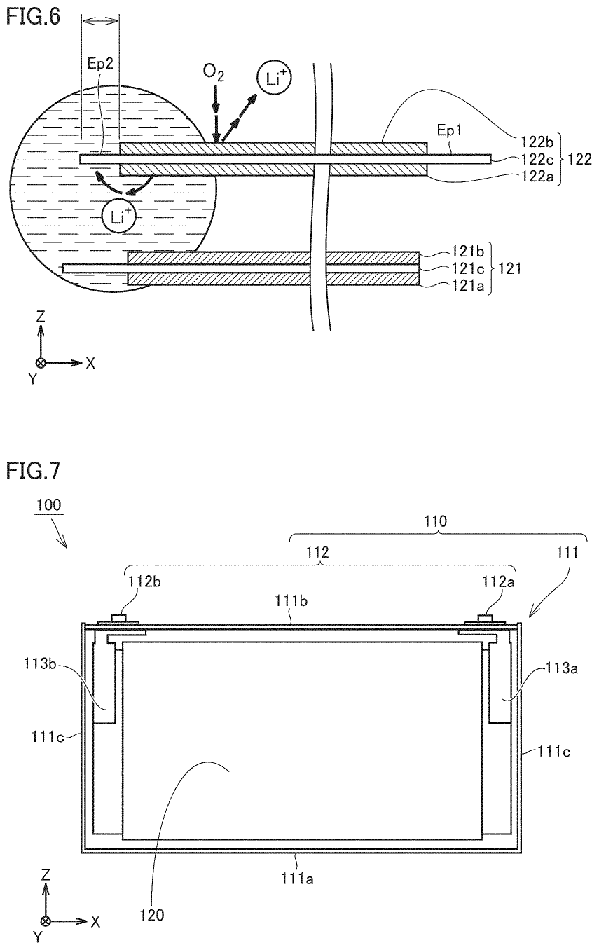

Positive electrode plate 121 includes a positive electrode substrate 121c, a positive electrode active material layer 121a, and a positive electrode active material layer 121b. Each of positive electrode active material layer 121a and positive electrode active material layer 121b is disposed on a surface of positive electrode substrate 121c. Positive electrode active material layer 121a (inner peripheral side) and positive electrode active material layer 121b (outer peripheral side) are in such a relation that they are located on the front and rear sides respectively (see FIG. 6).

Positive electrode substrate 121c may have a thickness of 10 to 30 μm, for example. Positive electrode substrate 121c may be an Al foil or the like, for example. Each of positive electrode active material layers 121a, 121b may have a thickness of 10 to 200 μm, for example. Each of positive electrode active material layers 121a, 121b includes a positive electrode active material. Each of positive electrode active material layers 121a, 121b may further include a conductive material, a binder, and the like, for example. For example, each of positive electrode active material layers 121a, 121b may consist essentially of 0.1 to 10% of the binder in mass fraction, 0.1 to 10% of the conductive material in mass fraction, and a remainder of the positive electrode active material. The conductive material can include any component. The conductive material may include carbon black or the like, for example. The binder can include any component. The binder may include polyvinylidene difluoride (PVdF) or the like, for example.

The positive electrode active material includes a transition metal oxide. That is, positive electrode plate 121 includes the transition metal oxide. The positive electrode active material may include at least one selected from a group consisting of LiCoO₂, LiNiO₂, LiMnO₂, LiMn₂O₄, Li(NiCoMn)O₂, and Li(NiCoAl)O₂, for example.

The positive electrode active material may be expressed by, for example, the following formula:

Li₁₋ₐNiₓCo_{y}Mn_{1-x-y}O₂.

In the above formula, “a” satisfies a relation of “−0.3≤a≤0.3”. “x” satisfies a relation of “0≤x≤1”. “x” may satisfy a relation of “0.5≤x≤0.9”, for example. “y” satisfies a relation of “0≤y≤1”. “y” may satisfy a relation of “0.1≤y≤0.5”, for example.

(Negative Electrode Plate)

Negative electrode plate 122 is a sheet having a strip-like shape. Winding of negative electrode plate 122 is terminated in flat portion Fp (see FIG. 5). The winding of negative electrode plate 122 may be terminated in second curved portion Rp2 immediately preceding flat portion Fp. It should be noted that the winding-terminated position of negative electrode plate 122 is close to the terminal end of laminated assembly 125 (adhesive tape 126) with respect to the winding-terminated position of positive electrode plate 121.

For example, as the dynamic coefficient of friction is larger between negative electrode plate 122 and separator 123, the loosened winding is expected to be more reduced. The dynamic coefficient of friction between negative electrode plate 122 and separator 123 may be, for example, 0.40 to 0.80.

Negative electrode plate 122 includes a negative electrode substrate 122c, a negative electrode active material layer 122a, and a negative electrode active material layer 122b. Each of negative electrode active material layer 122a and negative electrode active material layer 122b is disposed on a surface of negative electrode substrate 122c. Negative electrode active material layer 122a (inner peripheral side) and negative electrode active material layer 122b (outer peripheral side) are in such a relation that they are located on the front and rear sides respectively (see FIG. 6).

Negative electrode substrate 122c may have a thickness of, for example, 5 to 30 μm. Negative electrode substrate 122c may be, for example, a Cu foil or the like. Negative electrode substrate 122c includes exposed portions (first exposed portions Ep1 and second exposed portions Ep2) on its both sides in the width direction (X axis direction). Each of first exposed portion Ep1 and second exposed portion Ep2 protrudes outward with respect to a corresponding one of the end surfaces of negative electrode active material layers 122a, 122b. It should be noted that each of the “end surfaces of negative electrode active material layers 122a, 122b” may be inclined or may not be smooth.

Negative electrode collector plate 113b is joined to first exposed portion Ep1. Therefore, the length of first exposed portion Ep1 can be, for example, several mm to several cm. The term “length” represents a dimension in the X axis direction. First exposed portion Ep1 can have a sufficient length. By the joining of negative electrode collector plate 113b, a space between portions of negative electrode substrate 122c can be closed. Also, by the joining of negative electrode collector plate 113b, negative electrode plate 122 can be partially fixed. Therefore, it is considered that the diffusion of Li⁺ to the non-facing portion is less likely to occur on the first exposed portion Ep1 side.

Second exposed portion Ep2 is located opposite to first exposed portion Ep1 in the X axis direction. The second exposed portion Ep2 side is not substantially fixed. When second exposed portion Ep2 is not provided, it is considered that the diffusion of Li⁺ to the non-facing portion is likely to occur.

Second exposed portion Ep2 in the present embodiment can physically inhibit the diffusion of Li⁺ to the non-facing portion. The length of second exposed portion Ep2 may be larger than the thickness of each of negative electrode active material layers 122a, 122b, for example. Since second exposed portion Ep2 is longer than the thickness of each of negative electrode active material layers 122a, 122b, it is expected that the diffusion of Li⁺ to the non-facing portion is less likely to occur.

As second exposed portion Ep2 is longer, it is considered that the diffusion of Li⁺ to the non-facing portion can be more inhibited. The length of second exposed portion Ep2 may be more than or equal to 0.8 mm, for example. However, when second exposed portion Ep2 is too long, a joining position of positive electrode collector plate 113a may be restricted, for example. The length of second exposed portion Ep2 may be, for example, less than or equal to 2.0 mm.

Each of negative electrode active material layers 122a, 122b may have a thickness of, for example, 10 to 200 μm. Each of negative electrode active material layers 122a, 122b includes a negative electrode active material. Each of negative electrode active material layers 122a, 122b may further include, for example, a binder or the like. For example, each of negative electrode active material layers 122a, 122b may consist essentially of 0.1 to 10% of the binder in mass fraction, and a remainder of the negative electrode active material. The binder can include any component. The binder may include, for example, at least one selected from a group consisting of carboxymethyl cellulose (CMC) and styrene-butadiene rubber (SBR).

The negative electrode active material may include any component. The negative electrode active material may include, for example, at least one selected from a group consisting of graphite, soft carbon, hard carbon, silicon, silicon oxide, a silicon-based alloy, tin, tin oxide, a tin-based alloy, and Li₄Ti₅O₁₂.

«Amount of Precipitation of Transition Metal»

Since the diffusion of Li⁺ to the non-facing portion is inhibited, an amount of precipitation of the transition metal on negative electrode plate 122 can be reduced. The amount of precipitation of the transition metal can be quantified by XRF (X-ray fluorescence).

In the outermost perimeter of electrode assembly 120, a range from the winding-terminated position of negative electrode plate 122 to a position corresponding to one round of the winding thereof is cut out from negative electrode plate 122 as a sample piece. The sample piece can have a planar size of, for example, 110 mm×100 mm. Measurement conditions for the XRF can be as follows.

Scan size: 4 mm×7 mm

Image size: 80×140 pixels

Size of one point: 50 μm/pixel

Measurement time for one point: 20.00 ms

Number of added frames: 3

Required mapping time: 13.4 min

Tube voltage: 45 kV

Tube current: 900 μA

Filter: OFF

Collimator: none

When a plurality of types of transition metals are detected, the amount of precipitation represents the total amount of the transition metals. The amount of precipitation may be, for example, less than 100 cps. The amount of precipitation may be, for example, 1 to 90 cps, or 83 to 90 cps.

«Separator»

Separator 123 is a porous sheet. Separator 123 is electrically insulative. Separator 123 may include, for example, a polyolefin-based resin or the like. Separator 123 may consist essentially of a polyolefin-based resin, for example. The polyolefin-based resin may include at least one selected from a group consisting of polyethylene (PE) and polypropylene (PP), for example. Separator 123 may have a single-layer structure, for example. Separator 123 may consist essentially of a PE layer, for example. Separator 123 may have a multilayer structure, for example. Separator 123 may be formed by layering a PP layer, a PE layer, and a PP layer in this order, for example. A heat-resistant layer (ceramic particle layer) or the like may be formed on the surface of separator 30, for example.

«Electrolyte Solution»

Electrode assembly 120 is immersed in at least part of the electrolyte solution. Part of the electrolyte solution may be stored at bottom portion 111a of container 111.

The electrolyte solution includes a solvent and a supporting electrolyte. The solvent is aprotic. The solvent can include any component. For example, the solvent may include at least one selected from a group consisting of ethylene carbonate (EC), propylene carbonate (PC), dimethyl carbonate (DMC), ethyl methyl carbonate (EMC), and diethyl carbonate (DEC). The supporting electrolyte is dissolved in the solvent.

The supporting electrolyte may include LiPF₆ or the like, for example. The supporting electrolyte may have a molar concentration of 0.5 to 2.0 mol/L, for example. The electrolyte solution may further include any additive in addition to the solvent and the supporting electrolyte.

### EXAMPLES

Hereinafter, an example of the present technology (also referred to as “the present example” in the present specification) will be described. However, the scope of the present technology is not restricted by the following description.

<Manufacturing of Nonaqueous Electrolyte Secondary Battery>

Test batteries according to No. 1 to No. 7 were manufactured (see Table 1 below). In a process of manufacturing each of the test batteries according to No. 1 to No. 6, the liquid injecting step and the sealing step were performed under a dry air atmosphere (with an oxygen partial pressure of 160 mmHg). In a process of manufacturing the test battery according to No. 7, the liquid injecting step and the sealing step were performed under a nitrogen atmosphere (with an oxygen gas concentration of less than or equal to 1 ppm).

<Evaluations>

The amount of precipitation of the transition metal on the negative electrode plate was measured by XRF. The positive electrode active material in the present example included Li(NiCoMn)O₂. Thus, the three transition metals (Ni, Co, Mn) were detected from the negative electrode plate. The column “Amount of Precipitation of Transition Metals” in Table 1 below represents the total amount of Ni, Co and Mn.

After the manufacturing of each of the test batteries, a ratio of occurrence of voltage failure was calculated. The ratio of occurrence of voltage failure was calculated by dividing the number of failed products by the number of manufactured products.

<Results>

In Table 1, it is observed that as the amount of precipitation of the transition metals is larger, the ratio of occurrence of voltage failure tends to be increased.

Each of the test batteries (No. 1 to No. 3) in each of which the winding-terminated position of the positive electrode plate is located in the second curved portion tends to have a smaller amount of precipitation of transition metals than each of the test batteries (No. 4 to No. 6) in each of which the winding-terminated position of the positive electrode plate is located in the flat portion. This is presumably because the loosened winding is less likely to occur.

It is observed that when the length of the second exposed portion is more than 0 mm, the amount of precipitation of the transition metals tends to be decreased. In each of the test batteries (No. 1 and No. 2) in each of which the winding-terminated position of the positive electrode plate is located in the second curved portion and the length of the second exposed portion is more than 0 mm, the amount of precipitation of the transition metals is significantly reduced.

<Clauses>

The present technology also provides a method of manufacturing a nonaqueous electrolyte secondary battery.

[5] A method of manufacturing a nonaqueous electrolyte secondary battery includes (a) to (d) as follows:

(a) The electrode assembly described in [1] is assembled.

(b) The electrode assembly is accommodated in the exterior package.

(c) The electrolyte solution is injected into the exterior package under an oxygen-containing atmosphere.

(d) The exterior package is sealed under the oxygen-containing atmosphere to manufacture the nonaqueous electrolyte secondary battery.

[6] The oxygen-containing atmosphere may be a dry air atmosphere, for example. The dry air atmosphere may have a dew point temperature of −80 to 0° C. or may have a dew point temperature of −70 to −20° C., for example.

The present embodiment and the present example are illustrative in any respects. The present embodiment and the present example are not restrictive. The scope of the present technology includes any modifications within the scope and meaning equivalent to the terms of the claims. For example, it is initially expected to extract freely configurations from the present embodiment and the present example and combine them freely.

What is claimed is:

1. A nonaqueous electrolyte secondary battery comprising:
an exterior package;
an electrode assembly; and
an electrolyte solution, wherein
the exterior package accommodates the electrode assembly and the electrolyte solution,
the exterior package includes a container and an external terminal,
the container includes a bottom portion, a top portion, and a sidewall,
the sidewall connects the bottom portion and the top portion to each other,
the external terminal is attached to the top portion,
the electrode assembly includes a laminated assembly,
the laminated assembly includes a positive electrode plate, a separator, and a negative electrode plate,
each of the positive electrode plate, the separator, and the negative electrode plate has a strip-like planar shape,
the positive electrode plate, the separator, and the negative electrode plate are layered,
the separator separates the positive electrode plate and the negative electrode plate from each other,
the laminated assembly is spirally wound,
in a cross section orthogonal to a winding axis of the laminated assembly, the electrode assembly includes a first curved portion, a flat portion, and a second curved portion,
in each of the first curved portion and the second curved portion, the laminated assembly is curved,
in the flat portion, the laminated assembly is flat,
in a direction connecting the bottom portion and the top portion of the container to each other, the second curved portion is close to the bottom portion with respect to the first curved portion,
the flat portion connects the first curved portion and the second curved portion to each other,
winding of the positive electrode plate is terminated in the second curved portion,
a winding-terminated position of the positive electrode plate is located beyond a peak of the second curved portion,
the positive electrode plate includes a transition metal oxide,
the negative electrode plate includes a negative electrode substrate and a negative electrode active material layer,
the negative electrode active material layer is disposed on a surface of the negative electrode substrate,
the negative electrode substrate includes an exposed portion on each of both sides of the negative electrode plate in a width direction, and
the exposed portion protrudes outward with respect to an end surface of the negative electrode active material layer.

2. The nonaqueous electrolyte secondary battery according to claim 1, wherein a length of the exposed portion is larger than a thickness of the negative electrode active material layer.

3. The nonaqueous electrolyte secondary battery according to claim 2, wherein the length of the exposed portion is more than or equal to 0.8 mm.

4. The nonaqueous electrolyte secondary battery according to claim 1, wherein
the container is sealed, and
gas in the container has an oxygen gas concentration of more than or equal to 1% and less than or equal to 21% in mole fraction.
